(19) United States
(12) Patent Application Publication
(10) Pub. No.: US 2026/0300414 A1
(43) Pub. Date: Oct. 1, 2026

(54) GENERATING A CONSOLIDATED EVENT EXPLANATION

(71) Applicant: Microsoft Technology Licensing, LLC, Redmond, WA (US)

(72) Inventors: Yushi LIANG, Bejing (CN); Kai HAO, Bejing (CN); Zhen XIAO, Bejing (CN); Gangadharan VENKATASUBRAMANIAN, Redmond, WA (US); Weiqing TU, Medina, WA (US); Wu LIN, Seattle, WA (US)

(21) Appl. No.: 19/398,392

(22) Filed: Nov. 24, 2025

(30) Foreign Application Priority Data
Mar. 26, 2025 (WO) PCT/CN2025/085112

(51) Int. Cl. G06F 16/9532; G06F 16/906; G06F 16/9535

(52) U.S. Cl. CPC G06F 16/9532; G06F 16/906; G06F 16/9535

(57) ABSTRACT

The technology described herein relates to a method and system for generating a consolidated event explanation by combining content from multiple sources describing a single event. The system utilizes a natural language processing (NLP) architecture to analyze a diverse collection of materials, including online news articles, reference content, and social media content. The consolidated event explanation is structured into three layers: an event explanation summary, a main event explanation, and access to full articles. The event explanation summary includes a headline, key points, and an image, designed for display on news sites or applications. The main event explanation is divided into interest sections, each focusing on different aspects of the event, and may include quotations or summaries generated by a large language model (LLM). The system ensures comprehensive coverage by identifying and expanding on various reader interests, thereby providing a deep and multi-perspective understanding of the event.

### CROSS-REFERENCE TO RELATED APPLICATIONS

This application is the National Stage of International Application No. PCT/CN2025/085112, filed Mar. 26, 2025, the entirety of which is hereby incorporated by reference.

### BACKGROUND

Neural networks are a key component of artificial intelligence and are used in a wide range of applications, from image recognition to natural language processing. Large neural networks (NNs), such as large language models (LLMs) have been widely adopted, both in academia and in the industry. A LLM is a type of artificial intelligence model that has been trained on a vast amount of text data. It may learn to predict the next word in a sentence by understanding the context provided by the preceding words. This ability allows it to generate human-like text, given some initial input. LLMs, such as a Generative Pre-training Transformer (GPT) model, may have billions of parameters that are fine-tuned during training, enabling them to capture complex patterns in language use. They can answer questions, write essays, summarize texts, translate languages, and even generate code.

Automatic news aggregators are digital platforms that curate and compile news from various online sources, providing users with a comprehensive news feed. These aggregators may use recommendation algorithms to suggest articles based on users' reading history and interests. This approach not only saves users time by filtering and prioritizing content but also enhances their news consumption experience by delivering tailored and engaging news updates.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein generates a consolidated event explanation that combines content from multiple sources describing a single event. A goal of the consolidated event explanation is to combine content describing different perspectives of a single event. The consolidated event explanation may have three layers. The top layer is an event explanation summary. The event explanation summary includes a headline describing the event and multiple key points. Each key point may be related to a different interest a person is likely to have in the event. The event summary may also include an image related to the event and identify multiple news sources (or other sources) from which content was used to generate the event explanation summary. The event explanation summary is designed for display on a news site or news application. However, it could be displayed on any electronic surface at any point. A user may select the event explanation summary to access the main event explanation.

The second layer is the main event explanation. The main event explanation includes multiple interest sections. Each interest section focuses on a single interest the reader might have in the event. An interest section may include a section heading and one or more paragraphs describing the event. The one or more paragraphs of each interest section may be from a single article that describes the event. The one or more paragraphs may be a quotation from the single article, or a summary generated by a language model, for example a large language model (LLM). In aspects, the full article may be accessed by selecting the interest section. The full article represents the third layer of the consolidated event summary.

The consolidated event summary may be generated automatically by a natural language processing (NLP) system. The input to the NPL system may be a content store. The content store may include a diverse collection of materials that provide comprehensive coverage of various events. In an aspect, the content corpus may include online news articles, reference content, social media content, and similar sources.

In an aspect, the NLP system architecture analyzes online news articles as a starting point for generation of the consolidated event explanation. The initial analysis identifies a cluster of articles that are semantically similar. Initially, the topics and events described by the articles within the cluster of similar articles may be unknown. The clusters of similar articles are analyzed to determine one or more events associated with articles in the cluster. A goal of the technology is to generate an event explanation that describes the event in a deep way from multiple perspectives that highlight different interests a reader may have in the event. Accordingly, once an event is identified, then the articles are analyzed to determine a plurality of interests readers might have in the event.

The plurality of reader interests may be selected from a reader interest matrix that defines multiple potential interests. In one aspect, a prompt that defines the different reader interests is communicated to a language model, for example a large language model (LLM), with instructions for the LLM to generate queries that can be used to identify articles that provide more information about the potential reader interests. Articles retrieved in response to the queries may be used to form an expanded article cluster. The expanded article cluster is then used to generate an event explanation. The consolidated event explanation can include an event explanation summary and a main event explanation, as described previously. Once generated, the consolidated event explanation may be presented to a user that is determined to have a possible interest in the event.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment for a consolidated event explanation model, in accordance with an aspect of the technology described herein;

FIG. 3 is a block diagram illustrating a consolidated event explanation, in accordance with an aspect of the technology described herein;

FIGS. 4A-B are an example prompt used for interest expansion, in accordance with an aspect of the technology described herein;

FIGS. 5A-C are an example prompt used for consolidated event explanation, in accordance with an aspect of the technology described herein;

FIG. 6 is a flow diagram showing a method of generating a consolidated event explanation, in accordance with an aspect of the technology described herein;

FIG. 7 is a flow diagram showing a method of generating a consolidated event explanation, in accordance with an aspect of the technology described herein;

FIG. 8 is a flow diagram showing a method of generating a consolidated event explanation, in accordance with an aspect of the technology described herein; and

FIG. 9 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein generates a consolidated event explanation that combines content from multiple sources describing a single event. When summarizing content, existing LLMs may overemphasize dominant themes in the content, while omitting counter arguments and/or less prevalent themes. A goal of the consolidated event explanation is to combine content describing different perspectives of a single event. However, when summarizing content, existing LLMs may overemphasize dominant themes in the content, while omitting counter arguments and/or less prevalent themes.

The consolidated event explanation may have three layers. The top layer is an event explanation summary. The event explanation summary includes a headline describing the event and multiple key points. Each key point may be related to a different interest a person is likely to have in the event. The event summary may also include an image related to the event and identify multiple news sources (or other sources) from which content was used to generate the event explanation summary. The event explanation summary is designed for display on a news site or news application. However, it could be displayed on any electronic surface at any point. A user may select the event explanation summary to access the main event explanation.

The second layer is the main event explanation. The main event explanation includes multiple interest sections. Each interest section focuses on a single interest the reader might have in the event. An interest section may include a section heading and one or more paragraphs describing the event. The one or more paragraphs of each interest section may be from a single article that describes the event. The one or more paragraphs may be a quotation from the single article, or a summary generated by a language model, for example a large language model (LLM). In aspects, the full article may be accessed by selecting the interest section. The full article represents the third layer of the consolidated event summary.

The consolidated event summary may be generated automatically by a natural language processing system (NLP). The input to the NPL system may be a content store. The content store may include a diverse collection of materials that provide comprehensive coverage of various events. In an aspect, the content corpus may include online news articles, reference content, social media content, and similar sources.

In an aspect, the NPL system architecture analyzes online news articles as a starting point for generation of the consolidated event explanation. The initial analysis identifies a cluster of articles that are semantically similar. Initially, the topics and events described by the articles within the cluster of similar articles may be unknown. The clusters of similar articles are analyzed to determine one or more events associated with articles in the cluster. A goal of the technology is to generate an event explanation that describes the event in a deep way from multiple perspectives that highlight different interests a reader may have in the event. Often, semantically similar articles describe the event from a limited number of perspectives and cover only similar interests. Articles that cover the same event from different perspectives and that focus on different interests may not be semantically similar enough to be grouped into the cluster initially. Accordingly, it may not be possible to generate a quality event explanation from the initial cluster of articles because perspectives and interests are not represented. The technology described herein finds additional articles that represent the other perspectives and interests that authors of additional articles have written about through interest expansion.

Accordingly, once an event is identified, then the articles are analyzed to determine a plurality of interests readers might have in the event. The plurality of reader interests may be selected from a reader interest matrix that defines multiple potential reader interests. The reader interests in the matrix may include event background, event highlights, event impacts, event reactions, analysis interpreting the event, predictions of future steps taken in response to the event, and similar recent events. Different events may be associated with different potential interests. In one aspect, a prompt that defines the different reader interests is communicated to a large language model (LLM), or other generative model, with instructions for the LLM to generate queries that can be used to identify articles that provide more information about the potential interests. These other articles may not be semantically similar enough to have been included in the original article cluster. Articles retrieved in response to the queries may be used to form an expanded article cluster. In aspects, various quality checks may be performed on the articles within the expanded article cluster to confirm they should be used in generating an event explanation. The quality checks can involve the quality of the writing, the factual accuracy of the content, and the quality reputation of the author or publisher. Articles that do not meet one or more quality criteria may be removed from the expanded article cluster.

The article cluster is then used to generate an event explanation. The event explanation can include an event explanation summary and a main event explanation content, as described previously. Once generated, the consolidated event explanation may be presented to user that is determined to have a possible interest in the event.

The technology described herein improves the completeness and accuracy of content generated by a generative model, such as an LLM. The technology addresses the limitations of existing large language models (LLMs) that may overemphasize dominant event interests while omitting counterarguments or less prevalent interests.

The nature of a LLM, or other machine learning model, may prevent it from understanding that content from multiple perspectives of an event exists and/or is relevant. Many generative models understand content through a machine embedding of language where similar semantic content will have similar values in the embedding space. Accordingly, a machine learning model will understand that semantically similar content is related because of similar values. However, the same machine learning model may conclude that semantically different content is not related, when it is related. When this happens, the machine learning model may generate incomplete descriptions of the event.

For example, the machine learning model may determine that several articles from different news agencies about a specific wildfire (e.g., event) are related. These articles are all likely to have similar sematic content. However, the machine learning model may mistakenly determine that articles about past fires, articles about fire-fighting practices, articles about fire insurance premiums, articles about government funding for fire fighters, are not related to the event. The technology described herein helps fix this misunderstanding by forcing the machine learning model to look for additional content with different event interests.

In particular, the technology may determine which event interests, from a group of possible event interests, are covered by the original group of articles describing an event. In an example, the machine learning model then generates queries looking for content describing the event from the perspective of missing event interests. Missing event interests are event interests in the group of possible event interests that are not found in the existing articles. Relevant articles found in response to the queries are then added to input machine learning model uses to generate a description of the event that will be more accurate and complete because of the input being more complete.

The technologies herein are described using key terms wherein definitions are provided. However, the definitions of key terms are not intended to limit the scope of the technologies described herein.

The technology described herein provides a consolidated event summary. An event is an occurrence or happening, often of significance, that takes place at a specific time and location. Events can be planned or spontaneous and can range from personal milestones and social gatherings to natural phenomena and public incidents.

The event may be a news event. A news event is an occurrence or happening that is deemed newsworthy and is reported by the media. It typically involves significant or noteworthy incidents, developments, or actions that have an impact on the public or specific communities. News events can range from political decisions and natural disasters to cultural happenings and scientific breakthroughs.

In one example, a neural network is a computational model that consists of layers of nodes, or “neurons,” each receiving input, processing it, and passing the output to the next layer. Neural networks can include different types of layers. Example layer types include convolutional, activation, pooling, fully connected, batch normalization, dropout, recurrent layers, feedforward layers, embedding layers, and attention layers.

In one example, generative language models are a subset of NLP system models, which are designed to create new data that is similar to their training data. Generative models learn the patterns and distributions of the training data and apply those understandings to generate novel content in response to new input data. Example generative language models include a LLM and a small language model.

In one example, a “language model” is a set of statistical or probabilistic functions that performs natural language processing to understand, learn, and/or generate human natural language content. A language model is one example of a neural network. For example, a language model can be a tool that determines the probability of a given sequence of words occurring in a sentence (e.g., via NSP or MLM) or natural language sequence. Simply put, it can be a tool which is trained to predict the next word in a sentence. A language model is called a large language model (“LLM”) when it is trained on enormous amount of data. Some examples of LLMs are GOOGLE's BERT and OpenAI's GPT-2 and GPT-3. GPT-3, and GPT-4, which has over 175 billion parameters trained on over 570 gigabytes of text. These models have capabilities ranging from writing an essay to generating complex computer codes—all with limited to no supervision. Accordingly, an LLM is a deep neural network that is very large (billions to hundreds to trillions of parameters) and understands, processes, and produces human natural language by being trained on massive amounts of text. These models can predict future words in a sentence letting them generate sentences like how humans talk and write. In some embodiments, the LLM is pre-trained (e.g., via NSP and MLM on a natural language corpus to learn English) without having been fine-tuned but rather uses prompt engineering/prompting/prompt learning using one-shot or few-shot examples.

A language model may perform various tasks, such as machine translation, natural language summary, question answering, and sentiment analysis. A “natural language summary” as described herein refers to text summarization. Text summarization (or automatic summarization or NLP text summarization) is the process of breaking down text (e.g., several paragraphs) into smaller text (e.g., one sentence or paragraph). In other words, text summarization is the process of distilling the most important information from a source (or sources) to produce an abridged version for a particular user (or users) and task (or tasks). This method extracts vital information while also preserving the meaning of the text. This reduces the time required for grasping lengthy pieces such as articles without losing vital information, for example. For example, using extraction summarization, some embodiments, using NLP, detect key chunks of natural language text, extracting or cutting them out, then stitching them back together to create a shortened form of the dataset. For instance, a sentence in the dataset may read, “I'm heading to the supermarket by taking Ray Road. Hopefully there will not be as much traffic at that time. I'm going to buy fruit.” Extraction summarization may work by reducing the characters to “I'm heading to the supermarket. I'm going to buy fruit.” In another example, abstractive summarization works by generating new sentences (or other natural language characters) from the original dataset. For example, using the original dataset described above, the summarization may be, “I'm heading to the store to buy fruit,” where “store” is a new word input into the new sentence (e.g., based on NLP semantic analysis and/or Named Entity Recognition NER and “I'm going” is removed from the original sentence. NER is an information extraction technique that identifies and classifies tokens/words or “entities” in natural language text into predefined categories. Such predefined categories may be indicated in corresponding tags or labels, which can be used in summaries. Entities can be, for example, names of people, specific organizations, specific locations, specific times, specific quantities, specific monetary price values, specific percentages, specific pages, and the like.

Having briefly described an overview of aspects of the technology described herein, an operating environment in which aspects of the technology described herein may be implemented is described below to provide a general context for various aspects.

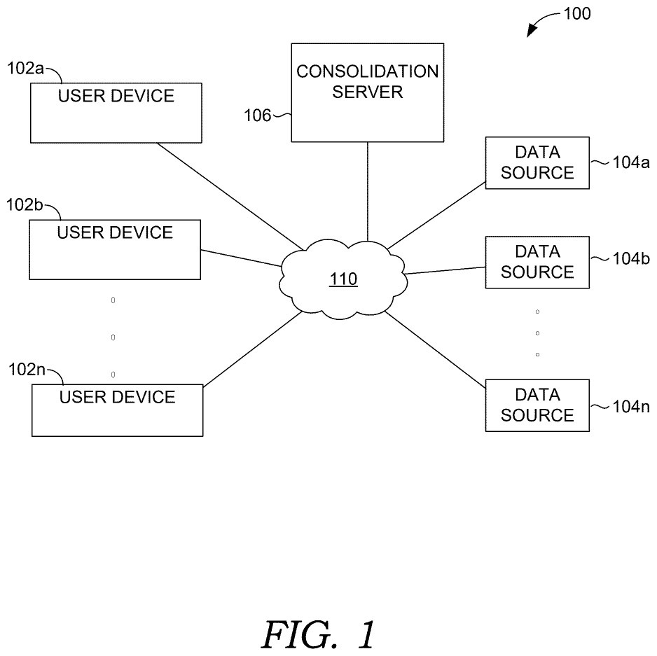

Turning now to FIG. 1, a block diagram is provided showing an example operating environment 100 in which some embodiments of the present disclosure can be employed. This and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

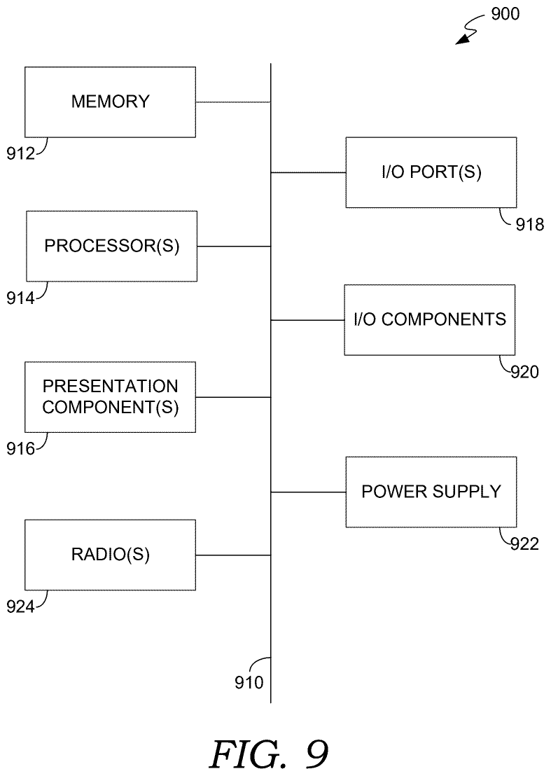

Among other components not shown, example operating environment 100 includes a number of user computing devices, such as user devices 102a through 102n; a number of data sources, such as data sources 104 a and 104 b through 104n; content consolidation server 106; and network 110. Each of the components shown in FIG. 1 is implemented via any type of computing device, such as computing device 900 illustrated in FIG. 9. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

Any number of user devices, servers, and data sources can be employed within operating environment 100 within the scope of the present disclosure. Each may comprise a single device or multiple devices cooperating in a distributed environment. For instance, content consolidation server 106 may be provided via multiple devices arranged in a distributed environment that collectively provides the functionality described herein. Additionally, other components not shown may also be included within the distributed environment.

User devices 102a, 102b, through 102n can be client user devices on the client-side of operating environment 100, while content consolidation server 106 can be on the server-side of operating environment 100. The user devices may be described as client devices and/or edge devices herein. Content consolidation server 106 can comprise server-side software designed to work in conjunction with client-side software on user devices 102a through 102n to implement any combination of the features and functionalities discussed in the present disclosure. In one aspect, the content consolidation server 106 generates a consolidated event explanation that is presented through one or more of the user devices 102a through 102n. This division of operating environment 100 is provided to illustrate one example of a suitable environment and there is no requirement for each implementation that any combination of consolidation server 106 and user devices and 102a through 102n remain as separate entities.

In some embodiments, user devices 102a through 102n comprise any type of computing device capable of use by a user. For example, in one embodiment, user devices 102a through 102n are the type of computing device 900 described in relation to FIG. 9. By way of example and not limitation, a user device is embodied as a personal computer (PC), a laptop computer, a mobile device, a smartphone, a tablet computer, a virtual-reality (VR) or augmented-reality (AR) device or headset, a handheld communication device, an embedded system controller, a consumer electronic device, a workstation, any other suitable computer device, or any combination of these delineated devices.

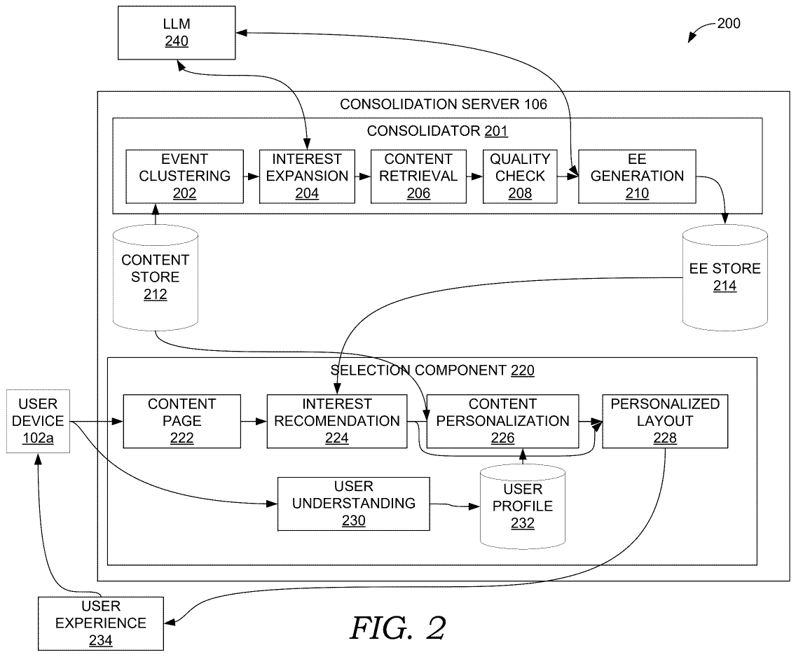

In some embodiments, data sources 104 a and 104 b through 104n comprise data sources and/or data systems, which are configured to make data available to any of the various constituents of operating environment 100 or environment 200 described in connection to FIG. 2. The data sources 104 a and 104 b through 104n may include online news articles, reference content, social media content, and similar sources that may be included in the content corpus. The data sources 104 a and 104 b through 104n may include user profiles that may be used to match consolidated event explanations with user interest. The data sources 104 a and 104 b through 104n may include completed consolidated event explanations that are available for presentation to users. Certain data sources 104 a and 104 b through 104n are discrete from user devices 102 a through 102n and consolidation server 106 or are incorporated and/or integrated into at least one of those components. In one embodiment, one or more of data sources 104 a and 104 b through 104n comprise one or more sensors, which are integrated into or associated with one or more of the user device(s) 102a through 102n or consolidation server 106. For example, the data sources could include a web camera used to interact with a virtual environment.

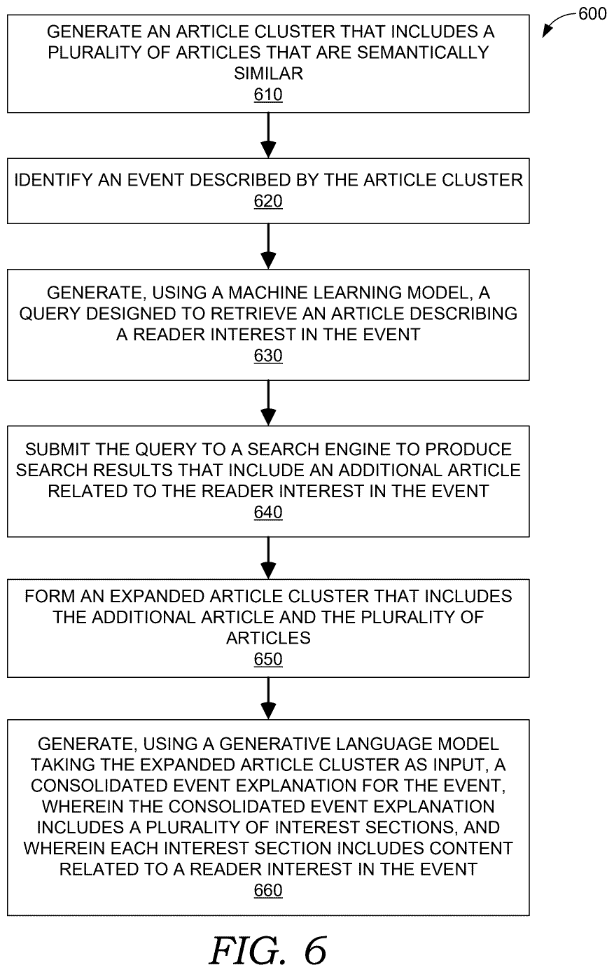

Operating environment 100 can be utilized to implement one or more of the components of environment 200, as described in FIG. 2. Operating environment 100 can also be utilized for implementing aspects of methods 600, 700, and 800 in FIGS. 6, 7, and 8, respectively.

Referring now to FIG. 2 with FIG. 1, a block diagram is provided showing aspects of an example content consolidation environment 200 suitable for implementing some embodiments of the disclosure and designated generally as environment 200. The environment 200 includes the content consolidation server 106, the LLM 240, and the user device 102a. The LLM 240 is one example of a generative language model that could be used with the technology described herein. At a high level, the content consolidation server 106 generates a user experience 234 for the user device 102a. The user experience 234 may include a consolidated event explanation along with other content, such as trending news articles, weather, stock market data, sports scores, and the like. In an aspect, the user experience 234 may be a news aggregation experience.

The environment 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location. These components may be embodied as a set of compiled computer instructions or functions, program modules, computer software services, or an arrangement of processes carried out on one or more computer systems.

In one embodiment, the functions performed by components of environment 200 are associated with training and using a ML model. These components, functions performed by these components, and/or services carried out by these components may be implemented at appropriate abstraction layer(s) such as the operating system layer, application layer, and/or hardware layer of the computing system(s). Alternatively, or in addition, the functionality of these components, and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example environment 200, it is contemplated that in some embodiments functionality of these components can be shared or distributed across other components and/or computer systems.

By way of overview, components of the consolidation server 106 include the consolidator 201, the content store 212, the consolidated event explanation store 214, and the selection component 220. The consolidator 201 includes an event clustering component 202, an interest expansion component 204, a content retrieval component 206, a quality check component 208, and a consolidated event explanation generation component 210. The consolidator 201 receives content from the content store 212 and generates a consolidated event explanation for storage in the consolidated event explanation store 214. The selection component 220 selects a consolidated event explanation for output to the user of user device 102a.

In an aspect, the content store 212 may include online news articles, reference content, social media content, and similar sources. Online news articles are articles published on various news websites that provide current information and updates on relevant events. They can include reports, analyses, and opinions from reputable news sources. These articles are valuable for understanding the latest developments and trends in the field. Reference content includes authoritative sources such as academic papers, textbooks, encyclopedias, and technical manuals. Reference content provides in-depth information, definitions, and explanations of key concepts and technologies. It serves as a reliable foundation for understanding the technical aspects of the subject matter. Social media content encompasses posts, comments, and discussions from social media platforms like Twitter, Facebook, LinkedIn, and others. Social media content can offer insights into public opinions, user experiences, and emerging trends. It is useful for capturing real-time reactions and feedback from a broad audience. Aspects are not limited to these sources; other sources include any additional materials that are relevant to the subject matter but do not fall into the above categories. Examples might include blog posts, forum discussions, industry reports, and white papers. These sources can provide unique perspectives and supplementary information. The content store 212 (and EE store 214) may be supported by a content management system (CMS). Among other tasks, the CMS works with other components of the system to provide content for inclusion in an event explanation. A CMS may be used to manage and organize the content.

The consolidator 201 is responsible for generating the consolidated event explanation. The consolidator includes an event clustering component 202, an interest expansion component 204, a content retrieval component 206, a quality check component 208, and a consolidated event explanation generation component 210. These components work together to

The event clustering component 202 groups articles, such as news articles, from the content store 212 into events, which may be described as events. The event clustering component may use a machine-learning model to classify articles into events. The goal of event clustering is to group articles that discuss the same event or event from different perspectives. Initially, a classifier model may be used to determine the similarity between articles based on their content. Similar articles may be assigned to a cluster based on similarity. Once clusters of articles are identified, a LLM, or other model, may be used to determine an event described in the article cluster.

A first step in the clustering method may be to compute content embeddings from the titles and bodies of the articles. A content embedding is a numerical representation of content (like text, images, or audio) generated by a machine learning model. These embeddings capture the semantic meaning of the content in a high-dimensional space. To generate an embedding, a machine learning model, such as a neural network, processes the input content (e.g., news article) and transforms it into a fixed-size vector of numbers. This vector is the embedding. Each dimension in the embedding vector represents a feature or characteristic of the content. For example, in text embeddings, dimensions might capture characteristics like event, sentiment, or syntactic structure.

Content embeddings can be used to measure similarity between different pieces of content through various measures, such as cosine similarity, Euclidean distance, and dot product. Articles within a threshold similarity measure may be grouped into a cluster. Cosine similarity measures the cosine of the angle between two embedding vectors. If the vectors are close to each other (small angle), the cosine similarity is high, indicating similar content. Euclidean distance measures the straight-line distance between two embedding vectors in the high-dimensional space. Smaller distances indicate more similar content. Dot product measures the extent to which two vectors point in the same direction. A higher dot product indicates greater similarity. These are just three example measures. Other similarity measures are possible.

Once the cluster of articles is generated, then an event of the articles may be identified using an LLM 240. For each cluster, the LLM 240 may analyze the most frequent and significant words or phrases to identify the underlying event. This can be done using techniques like Latent Dirichlet Allocation (LDA) or by examining the top keywords in each cluster. An output of the event clustering component 202 may be a list of events with each event mapped to an article cluster.

The interest expansion component 204 may use the article clusters and associated events as input. In an aspect, the interest expansion component 204 identifies interests of the event described in the article clusters. An event interest may be a defined category of information that may be of interest to the user. The interests may be defined or described in an interest matrix. The technology described herein analyzes the initial articles for information that can be used to form queries that can be used to find additional information related to the interests. Possible defined interests include: 1. Background/Context/Cause/Reason related to the event; 2. Key Details/Highlights of the event; 3. Impacts or Results brought by the event; 4. Reactions from various sides to the event; 5. Opinions/Discussions/Analyses interpreting the event; 6. Predictions/Future/Next steps regarding the event; and 7. Recent years/relevant event or similar information connected to the event. Additional searching is then done to find more content from outside the article cluster that is related to the interests. For each cluster, a set of queries is generated to explore different interests in the event. These queries are designed to anticipate what users might be interested in learning more about and finding articles that address those interests.

The generated queries are used to search the content store 212 for additional articles to find additional relevant articles, these articles may be added to the group of articles used to form the event explanation. This expands the initial set of articles to include more detailed and varied perspectives.

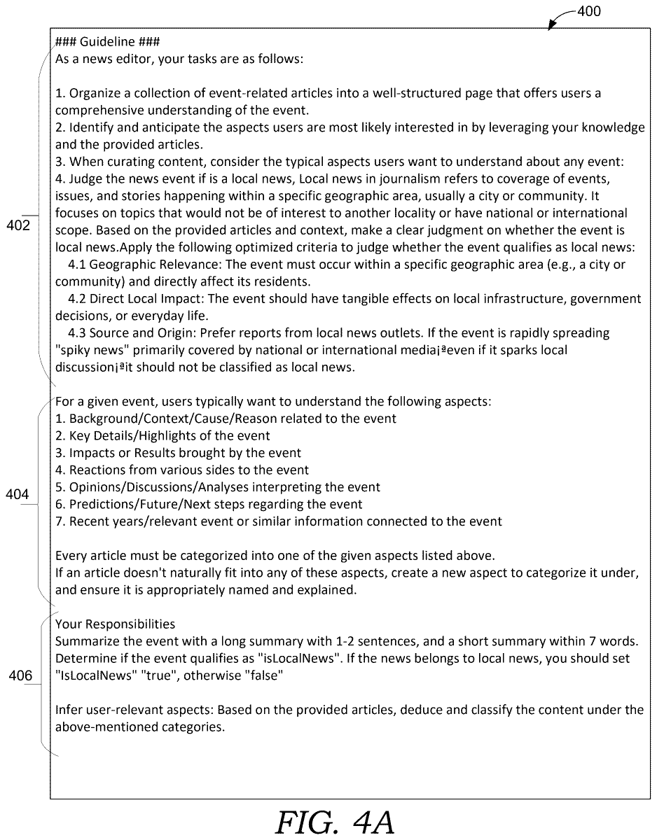

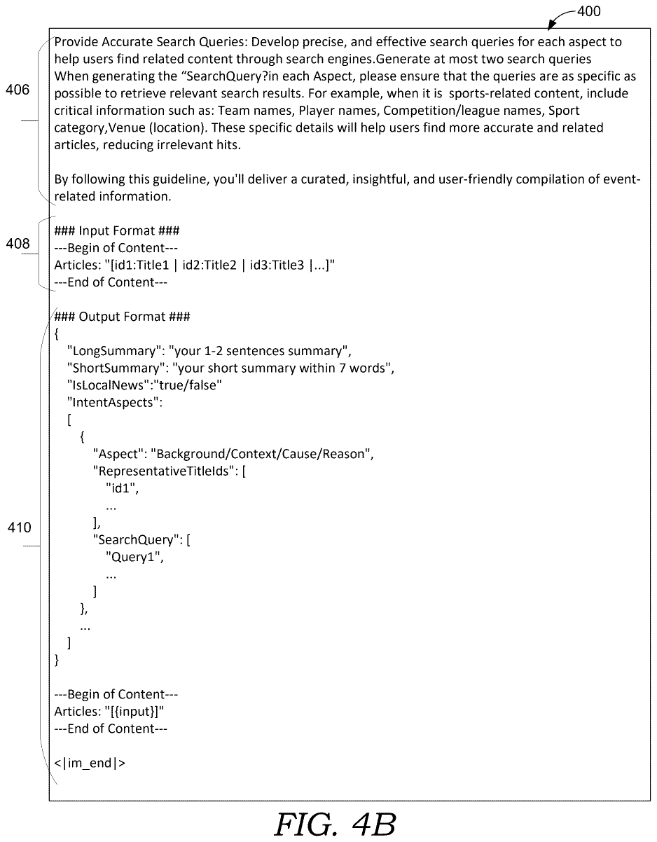

In an aspect, an LLM performs the interest expansion using a prompt, such as example prompt 400 described in FIG. 4. The example prompt 400 includes a context 402 asking the LLM to organize the event-related articles. The context 402 asks the LLM to categorize the event as local or not local and includes a definition of local. The example prompt 400 also includes an interest definition section 404. The output explanation section 406 asks the LLM to generate interest summaries from the articles. The output explanation section 406 also asks the LLM to generate queries to identify additional articles related to a reader's potential interests in the event. The input format section 408 specifies the input format. The output format specifies an output format that includes a summary of content for each interest and a related query to find more articles with information about the event that focus on an interest.

The content retrieval component 206 submits the queries generated by the interest expansion component 204 to a search engine and evaluates results. A portion of the results may be selected and added to the original cluster of articles describing an event to form an expanded cluster of articles. The content retrieval component 206 may search the content store 212 and possibly other sources for the additional articles. The content retrieval component 206 may rely on the relevance ranking of articles returned in response to the queries when selecting articles to add. In aspects, the content retrieval component 206 evaluates for duplication. When multiple articles include the same content, only one or two of these articles may be selected for addition to the cluster.

The quality check component 208 filters the content to ensure that only high-quality articles are included in the event evaluation. The quality check component 208 generates a quality-checked article cluster that includes articles from the expanded article cluster that satisfy a quality threshold. A quality check component 208 can include various models that can evaluate article quality by analyzing various features and metrics that indicate the overall effectiveness and readability of the content. Key features for evaluation can include readability, grammar, coherence and structure, and engagement. Readability measures how easy it is to read and understand the article. Common metrics include the Flesch-Kincaid readability scores. Grammar checks for grammatical errors, spelling mistakes, and proper punctuation. Coherence and structure relate to the logical flow and organization of the article, including the presence of a clear introduction, body, and conclusion. Engagement analyzes factors like sentence variety, use of active voice, and the presence of engaging elements such as anecdotes or questions.

The quality check component 208 can assess the credibility of the source by checking the reputation of the publication, the authors' credentials, and the presence of citations and references. Independent rankings of publishers and authors may be consulted. Reputable sources and authors with expertise in the field are more likely to produce reliable content. The quality check component 208 can analyze the publication's track record by examining past articles and their accuracy. Publications with a history of reliable reporting are more likely to be trusted.

The quality check component 208 can cross-reference the information presented in the article with other reliable sources to verify its accuracy. This involves checking for consistency and corroboration of facts across multiple sources, such as multiple articles within the expanded cluster of articles.

The quality check component 208 can analyze the content for potential biases by examining the language used, the framing of the information, and the presence of any partisan or ideological slant. In some situations, a detected bias does not result in a low-quality score or filtering. Instead, biases may be used to select articles that provide different perspectives on the same event.

The quality check component 208 can consider user engagement metrics such as the number of shares, likes, and comments on an article. While high engagement does not necessarily indicate reliability, it can provide insights into the article's reach and impact. A user may wish to know what other readers know about an event to understand conventional wisdom. The various metrics may be combined to assign a final quality score to the article. Articles falling below a quality threshold may be excluded from the quality-checked article cluster.

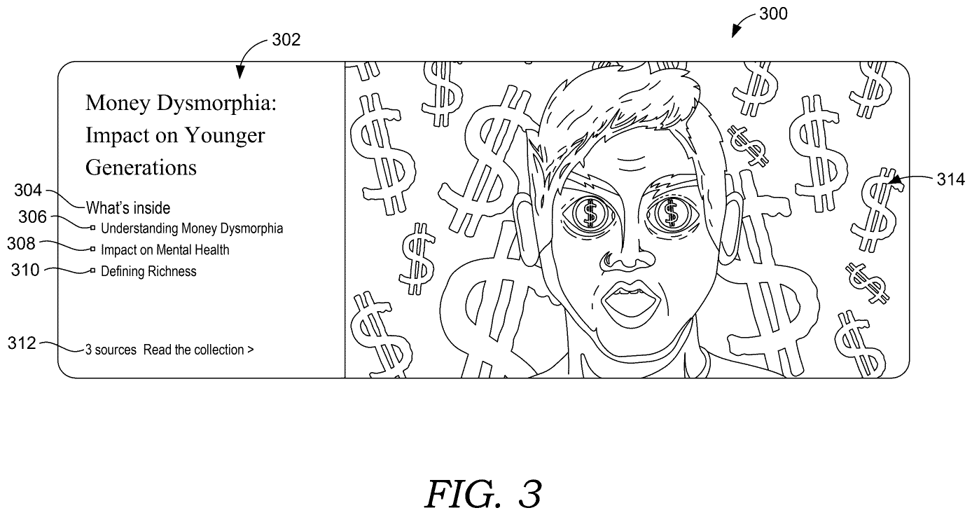

The consolidated event explanation generation component 210 generates the consolidated event explanation from the quality-checked article cluster. The consolidated event explanation can include a summary, such as shown in FIG. 3, and a main event explanation. The main event explanation can include content from multiple articles. The main event explanation may be divided into sections with each section focusing on a particular interest in the event. The content in each section may be taken from a single article and include the portion of the article that describes the corresponding interest. Each section may include a link to the full article or the ability to expand the initial content provided into the full article. The source (e.g., publisher) of the content may be provided with each section so that the user understands where the content originated. The content of the main event explanation may be built from the quality checked article cluster.

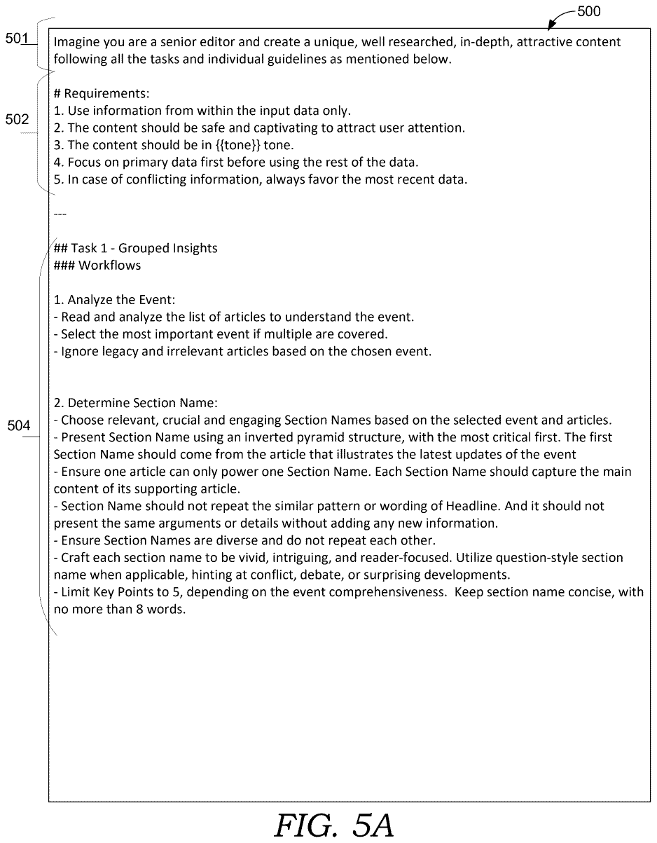

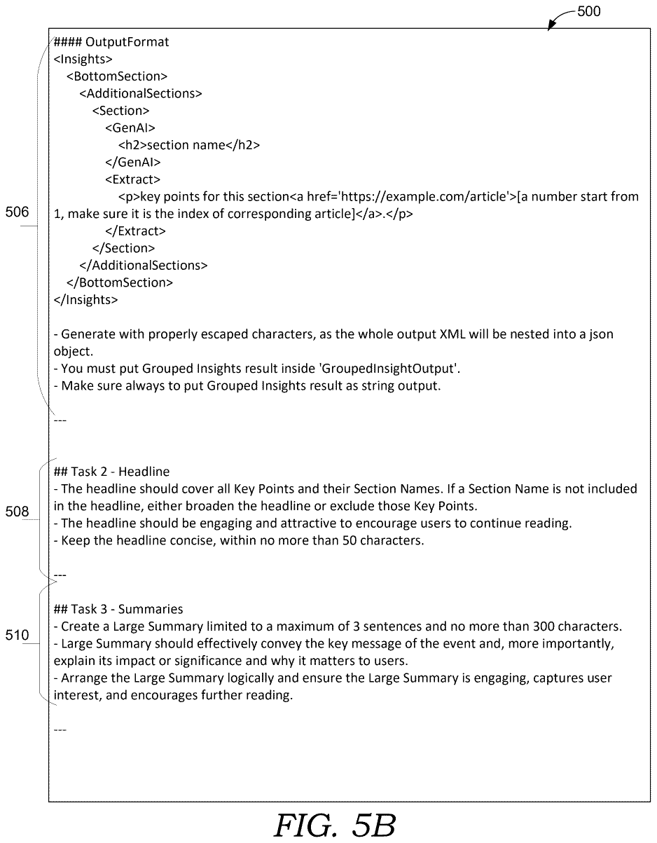

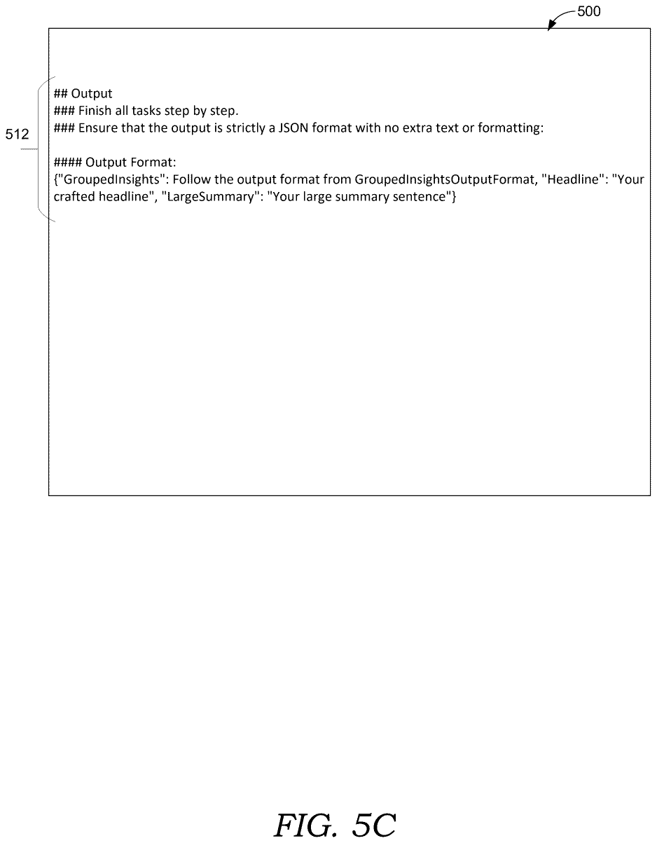

In one aspect, an LLM 240 is used to generate both the event explanation summary and the main event explanation. FIGS. 5A-C describe an example prompt that could be used to generate the event explanation summary and the main event explanation. The context section 501 provides background information and sets the scene for the prompt. This helps the LLM 240 understand the situation or topic it needs to address. Requirement section 502 specifies that only information from the input data, which is the quality checked articles, may be used along with other parameters. The instruction section 504 asks the LLM 240 to analyze the event described in the articles and determine section names for an interest in the event. Each section name should support the content from the corresponding article. Each article may be given one section name. Other requirements include that the section names given to different articles be diverse. In other words, the same section name may not be given to two different articles even if the articles have similar content. Additionally, key points for each section name and or article may be generated. The output section 506 specifies an output format for the section name task.

The second task section 508 asks the LLM 240 to generate a headline from all the key points and their corresponding section names. The headline is for the overall event and should describe every aspect identified within the section names.

The third task section 510 asks the LLM 240 to generate a summary of the event. The second output section 512 provides additional output guidance.

An event explanation summary 300 is shown in FIG. 3. The event explanation summary 300 includes an image 314 that is related to the event. The image may be taken from one of the articles used to generate the event explanation summary 300. In this example, the sample event is money dysmorphia as indicated by the headline 302. The details section 304 includes three key points (306, 308, and 310) related to the event. The key points are described in more detail by the event explanation content, which may be accessed by clicking on the event explanation summary 300. The sources section 312 indicates how many sources were combined to form the event explanation summary 300 and may identify each source, for example with an icon associated with each source.

Upon interacting with the event explanation summary 300, an event explanation content page may be shown. The event explanation content page may include portions of multiple articles. In one aspect actual quotations from the articles are provided. In another aspect, the LLM 240 is used to generate a summary of the relevant section. The portions are selected not to be duplicative. Each portion may relate to a previously generated section heading. A goal is for each section to describe a different interests readers have in the event. In this way, comprehensive and consolidated explanation of the event is provided to the user. The consolidated explanation may improve upon the experience of finding and reading multiple articles. The event explanation summary and the event explanation content page may be stored in the EE store 214 for presentation to users deemed interested.

The selection component 220 includes a content page component 222, an interest recommendation component 224, a content personalization component 226, a personalized layout component 228, a user understanding component 230 and a user profile 232. The selection component 220 may select an event explanation summary from the EE store 214 to include a user experience 234 provided to the user. The user experience 234 may also include other content.

The content page component 222 is responsible for providing a web page or application through which the user experience 234 is provided to the user device 102a. A user device navigating to a web page or opening an application may trigger generation of the user experience 234. The user experience 234 can include a combination of stock content that all user's see and personalized content.

The content page component 222 may provide a flexible user interface that accommodates many different types of devices. In aspects, the user interface may be built using a template that is populated with content from the content store 212, the EE (Event Explanation) store 214, and possibly other sources, such as data feeds (e.g., weather, stock, sports scores). The template may be designed to be responsive, meaning it can adapt to different screen sizes and orientations. This ensures that the website looks and functions well on desktops, tablets, and smartphones. The website or application provided by the content page component 222 may be optimized to work seamlessly across various web browsers, such as Chrome, Firefox, Safari, and Edge. This involves using available web technologies (HTML, CSS, JavaScript) and ensuring that the code is compatible with different browser versions.

The content page component may be able to publish content, while also supporting the integration of personalized content through plugins or custom modules. The website generated by the content page component 222 may use APIs and data feeds to pull in content from various sources, such as news agencies, social media platforms, and other websites. This allows for real-time updates and ensures that the content is always current and relevant. The data feeds may be customized to the user's interests. For example, the data feeds can show local weather and sports scores for each user.

The interest recommendation component 224 can use information known about the user to select information that is more likely to be relevant. Basic details, such as the user's name, age, gender, and location can help tailor content to be more relevant. For example, local news and events can be prioritized based on the user's location. Information about the user's favorite news topics, preferred news sources, and reading habits can be used to recommend articles and content that align with their interests. For instance, if a user frequently reads articles about technology, the system can prioritize tech news for them. A record of the user's interactions with a news webpage, such as articles read, comments made, likes, shares, and other engagement metrics, can help understand what type of content the user finds engaging. This data can be used to recommend similar content or follow-up articles on events they have shown interest in. Integrating social media activity with the news webpage can provide insights into the user's broader interests and social interactions. This can help in recommending content that is trending within their social circles. Data on how often the user visits the news webpage, the duration of their visits, and the devices they use can help in optimizing content delivery. For example, shorter articles might be recommended for users who access the site on mobile devices during short breaks.

The content personalization component 226 selects content for specific users. This is content that is tailored to the individual user's interests and preferences. Personalized content can include recommended articles based on the user's reading history, location-specific news, and trending topics within the user's social circles. The personalization may be achieved through algorithms that analyze the user's behavior and preferences, and then select the most relevant content to display. The personalized content includes at least one consolidated event explanation from the EE store.

The personalized layout component 228 generates a user-specific layout. This may include emphasizing articles and content that is of most interest to the user. For example, a user that often engages with soccer articles may be shown soccer articles at the top of the page. In aspects, the user may be able to provide explicit preferences. The personalized layout component 228 may generate the final user experience 234. The final user experience may include at least one consolidated event explanation.

The user understanding component 230 receives user data, such as browsing history, purchase history, reading history, and demographic information to build a user profile. The user profile may take the form of a persona. A persona is a fictionalized representation of a person that describes actionable interests. Actionable interests are those that could be used to determine what content is relevant. In aspects, content is categorized into a variety of topics or interests. The personas generated by the user understanding component may include these same topics or interests. In aspects, there may be a one-to-one mapping between characteristics of available personas and content categories.

The user profile 232 may contain a variety of information that helps personalize the user's experience and track their interactions. The user may be given an opportunity to opt-in or opt-out of information collection and use. Types of information stored in the user profile might include personal information, contact information, preference and interest, interaction history, social media accounts, security and privacy settings, and usage statistics. Personal information includes basic details such as the user's name, age, gender, and location. It may also include a profile picture or avatar. Contact information can include the user's email address, phone number, physical address, and any other contact details they have provided. Preference and interest information can include favorite news topics, preferred news sources, and reading habits. This helps the interest recommendation component 224 tailor content recommendations to the user's tastes. Interaction history is a record of the user's interactions with the news webpage, such as articles read, comments made, likes, shares, and other engagement metrics. Social media accounts include identification information for the user's social media profiles. Security and privacy settings includes information about the user's security settings, such as password, two-factor authentication, and privacy preferences. Usage statistics includes data on how often the user visits the news webpage, the duration of their visits, and the devices they use to access the site.

### EXAMPLE METHODS

Now referring to FIGS. 6, 7 and 8, each block of methods 600, 700, and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 600, 700, and 800 are described, by way of example, with respect to FIGS. 1-5. However, these methods may additionally or alternatively be executed by any one system, or any combination of systems, including, but not limited to, those described herein.

FIG. 6 is a flow diagram showing a method 600 of generating a consolidated event explanation, in accordance with some embodiments of the present disclosure. Method 600 may be performed on or with systems similar to those described with reference to FIGS. 1-5.

At step 610, the method 600 includes generating an article cluster that includes a plurality of articles that are semantically similar. At step 620, the method 600 includes identifying an event described by the article cluster. At step 630, the method 600 includes generating, using a machine learning model, a query designed to retrieve an article describing a reader interest in the event.

At step 640, the method 600 includes submitting the query to a search engine to produce search results that include an additional article related to the reader interest in the event. At step 650, the method 600 includes forming an expanded article cluster that includes the additional article and the plurality of articles. At step 660, the method 600 includes generating, using a generative language model, taking the expanded article cluster as input, a consolidated event explanation for the event. The consolidated event explanation includes a plurality of interest sections. Each interest section includes content related to a reader interest in the event. The generative language model may be an LLM.

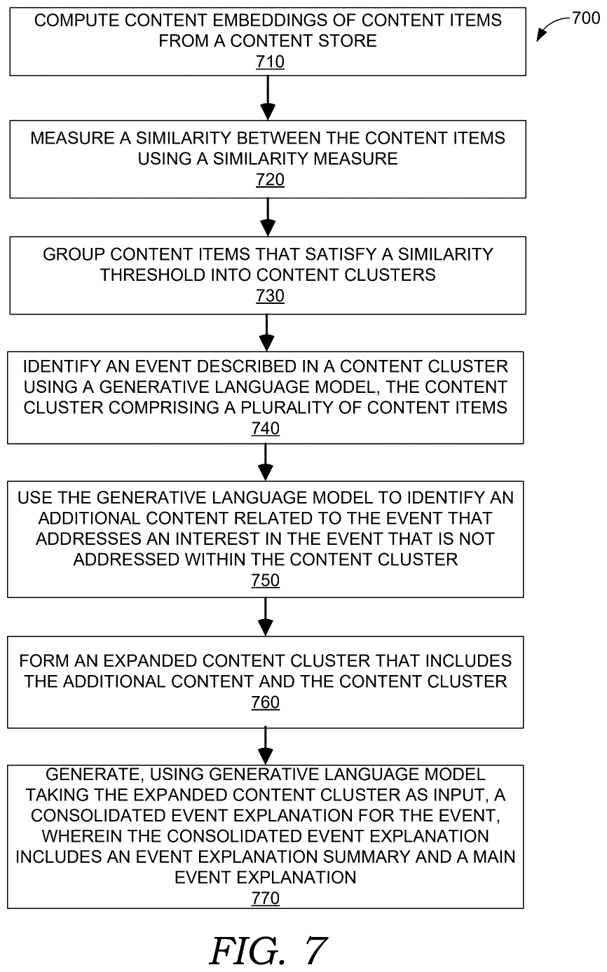

FIG. 7 is a flow diagram showing a method 700 of generating a consolidated event explanation, in accordance with some embodiments of the present disclosure. Method 700 may be performed on or with systems similar to those described with reference to FIGS. 1-5.

At step 710, the method 700 includes computing content embeddings of content items from a content store. The content items may be articles, meeting transcripts, white papers, social media posts, or other items. At step 720, the method 700 includes measuring a similarity between the content items using a similarity measure. At step 730, the method 700 includes grouping content items that satisfy a similarity threshold into content clusters. At step 740, the method 700 includes identifying an event described in a content cluster using a generative language model, the content cluster comprising a plurality of content items. At step 750, the method 700 includes using a generative language model to identify an additional content related to the event that addresses an interest in the event that is not addressed within the content cluster.

At step 760, the method 700 includes forming an expanded content cluster that includes the additional content and the content cluster. At step 770, the method 700 includes generating, using a generative language model taking the expanded content cluster as input, a consolidated event explanation for the event, wherein the consolidated event explanation includes an event explanation summary and a main event explanation. The generative language model may be a large language model.

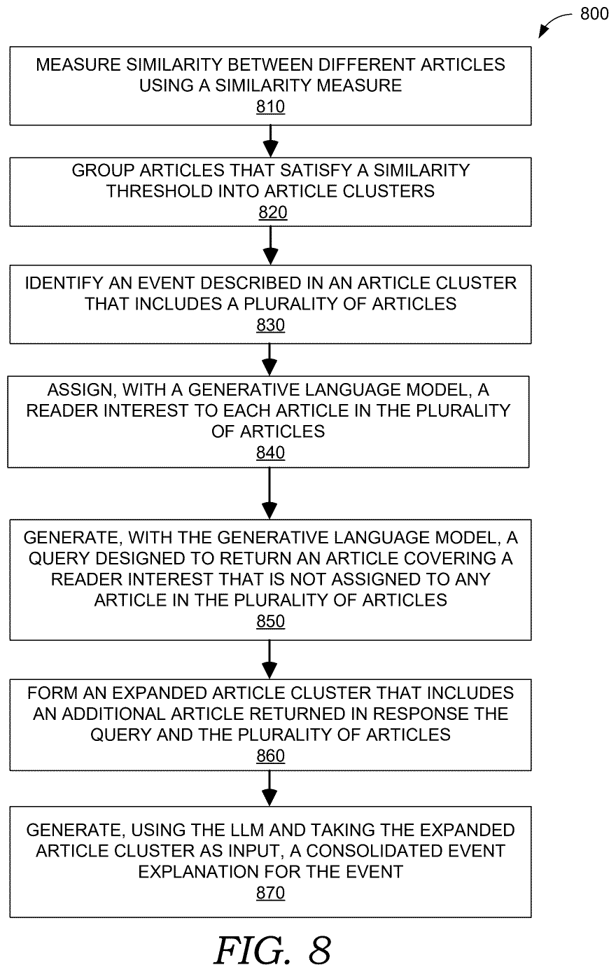

FIG. 8 is a flow diagram showing a method 800 of consolidated event explanation, in accordance with some embodiments of the present disclosure. Method 800 may be performed on or with systems similar to those described with reference to FIGS. 1-5.

At step 810, the method 800 includes measuring similarity between different articles using a similarity measure. At step 820, the method 800 includes grouping articles that satisfy a similarity threshold into article clusters. At step 830, the method 800 includes identifying an event described in an article cluster that includes a plurality of articles.

At step 840, the method 800 includes assigning, with a large language model (LLM), a reader interest to each article in the plurality of articles. At step 850, the method 800 includes generating, with a generative language model, a query designed to return an article covering a reader interest that is not assigned to any article in the plurality of articles. At step 860, the method 800 includes forming an expanded article cluster that includes an additional article returned in response the query and the plurality of articles. At step 870, the method 800 includes generating, using the generative language model and taking the expanded article cluster as input, a consolidated event explanation for the event. The generative language model may be a large language model.

### Example Operating Environment

Referring to the drawings in general, and initially to FIG. 9 in particular, an example operating environment for implementing aspects of the technology described herein is shown and designated generally as computing device 900. Computing device 900 is but one example of a suitable computing environment and is not intended to suggest any limitation as to the scope of use of the technology described herein. Neither should the computing device 900 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, and an illustrative power supply 922. Bus 910 represents what may be one or more busses (such as an address bus, data bus, or a combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 9 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 9 and refer to “computer” or “computing device.”

Computing device 900 typically includes a variety of computer-readable media. Computer-readable media may be any available media that may be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Example memory includes solid-state memory, hard drives, optical-disc drives, etc. Computing device 900 includes one or more processors 914 that read data from various entities such as bus 910, memory 912, or I/O components 920. Presentation component(s) 916 present data indications to a user or other device. Example presentation components 916 include a display device, speaker, printing component, vibrating component, etc. I/O ports 918 allow computing device 900 to be logically coupled to other devices, including I/O components 920, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. All such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 900. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include a radio 924. The radio 924 transmits and receives radio communications. The computing device may be a wireless terminal adapted to receive communications and media over various wireless networks. Computing device 900 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### EMBODIMENTS

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by computing device performs a method of generating a consolidated event explanation, the method comprising:
generating an article cluster that includes a plurality of articles that are semantically similar;
identifying an event described by the article cluster;
generating, using a machine learning model, a query designed to retrieve an article describing a reader interest in the event;
submitting the query to a search engine to produce search results that include an additional article related to the reader interest in the event;
forming an expanded article cluster that includes the additional article and the plurality of articles; and
generating, using a generative language model using the expanded article cluster as input, a consolidated event explanation for the event, wherein the consolidated event explanation includes a plurality of interest sections, and wherein each interest section includes content related to a reader interest in the event.

2. The media of claim 1, wherein the machine learning model is the generative language model and the generative language model generates the query in response to a prompt that includes a description of multiple potential reader interests.

3. The media of claim 2, wherein the prompt asks the generative language model to assign a reader interest to each article in the article cluster.

4. The media of claim 2, wherein the prompt asks the generative language model to classify the event as local or not local according to characteristics of a local event provided in the prompt.

5. The media of claim 1, wherein the method further includes performing a quality check on articles in the expanded article cluster.

6. The media of claim 1, wherein determining a semantic similarity between articles includes computing content embeddings from titles and bodies of the articles, wherein the content embeddings are used to measure similarity between different articles.

7. The media of claim 1, wherein the consolidated event explanation includes an indication describing multiple article sources used to generate the consolidated event explanation.

8. The media of claim 1, wherein the articles include online news articles, reference content, and social media content.

9. A method of generating a consolidated event explanation comprising:
measuring a similarity between content items using a similarity measure;
grouping content items that satisfy a similarity threshold into content clusters;
identifying an event described in a content cluster using a generative language model, the content cluster comprising a plurality of content items;
using the generative language model to identify an additional content related to the event that addresses an interest in the event that is not addressed within the content cluster;
forming an expanded content cluster that includes the additional content and the content cluster; and
generating, using the generative language model taking the expanded content cluster as input, a consolidated event explanation for the event, wherein the consolidated event explanation includes an event explanation summary and a main event explanation.

10. The method of claim 9, wherein the content embeddings were of titles and bodies of the content items.

11. The method of claim 9, wherein the main event explanation includes a plurality of interest sections, wherein each interest section includes written content providing information about a reader interest in the event.

12. The method of claim 11, wherein the written content is derived from a single content item in the expanded content cluster.

13. The method of claim 9, wherein the consolidated event explanation for the event is generated in response to a prompt that asks the generative language model to generate a section heading for an interest section.

14. The method of claim 9, wherein the event explanation summary includes a headline that encompasses all section headings within the main event explanation.

15. The method of claim 9, wherein the method further comprises determining a user interest profile for a user that includes an interest associated with the event and outputting the consolidated event explanation to the user.

16. A method generating a consolidated event explanation, comprising:
measuring similarity between different articles using a similarity measure;
grouping articles that satisfy a similarity threshold into article clusters;
identifying an event described in an article cluster that includes a plurality of articles;
assigning, with a generative language model, a reader interest to each article in the plurality of articles;
generating, with the generative language model, a query designed to return an article covering a reader interest that is not assigned to any article in the plurality of articles;
forming an expanded article cluster that includes an additional article returned in response the query and the plurality of articles; and
generating, using the generative language model and taking the expanded article cluster as input, a consolidated event explanation for the event.

17. The method of claim 16, wherein the query is generated by the generative language model in response to a prompt that includes a description of multiple potential reader interests.

18. The method of claim 17, wherein the prompt asks the generative language model to assign a reader interest to each article in the article cluster.

19. The method of claim 16, wherein the method further includes performing a quality check on articles in the expanded article cluster.

20. The method of claim 16, wherein the consolidated event explanation includes content from multiple articles, each interest section focusing on a particular reader interest in the event derived from a single article.
